(19) United States
(12) Patent Application Publication
(10) Pub. No.: US 2025/0305753 A1
(43) Pub. Date: Oct. 2, 2025

(54) CONDENSATE PAN SYSTEM

(71) Applicant: Backer EHP Inc., Murfreesboro, TN (US)

(72) Inventors: Ronald R. Barnes, Murfreesboro, TN (US); Dan R. Maxwell, Murfreesboro, TN (US); Robert K. Cockrell, Murfreesboro, TN (US)

(21) Appl. No.: 19/095,746

(22) Filed: Mar. 31, 2025

Related U.S. Application Data
(60) Provisional application No. 63/573,230, filed on Apr. 2, 2024.

(51) Int. Cl. F25D 21/14; H05B 1/02

(52) U.S. Cl. CPC F25D 21/14; H05B 1/0222; H05B 1/0252

(57) ABSTRACT

A condensate pan system is disclosed for evaporating a liquid therein by an electric heating element. The pan may include a reed float switch with sealed electrical contacts to detect the level of the liquid in the pan, a thermostat, and a relay with sealed electrical contacts. The relay is configured to close the circuit and provide electrical current to the electric heating element so long as the relay detects electrical continuity with the thermostat and with the reed float switch. If the electrical contacts of the reed float switch opens, which is indicative of a predetermined low liquid level, the relay is configured to open the electrical circuit to cease delivering electrical current to the electric heating element. Likewise, the relay is configured to open the electrical circuit to cease delivering electrical current to the electric heating element if the thermostat detects a temperature that exceeds a predetermined value.

### CROSS REFERENCE

This application claims the benefit of U.S. Provisional Application No. 63/573,230 filed on Apr. 2, 2024, which is incorporated by reference herein in its entirety.

### BACKGROUND

This disclosure relates generally to liquid evaporative devices, and more particularly to liquid evaporative devices that evaporate liquids using electric heating elements.

Following the advent of refrigeration systems, and especially those containing defrost mechanisms for melting ice, there has existed a need to transport and mitigate condensation arising from the use of such systems. One method of handling condensation arising from operating a refrigeration system is to transport the condensation to a drain, such as a sewer drain. Another method of handling the condensation is to collect the liquid condensate in a drain receptacle or condensate pan. Water or other liquid condensation collected in the drain receptacle or condensate pan may be allowed to evaporate, either directly into the air or by collecting the evaporate using an evaporate collection system. Sometimes electric heating elements are used to heat the liquid condensate to hasten evaporation of the liquid condensate from the pan, particularly when the amount of condensate collected is anticipated to exceed the volume of the pan. However, known electrically heated condensate receptacles or condensate pans are not configured to work in or near flammable refrigerants that circulate in refrigerant circuits associated with such refrigeration systems. Consequently, a fire risk may exist if a flammable or semi-flammable refrigerant leaks from a refrigerant circuit of a refrigeration system in proximity to an electrically energized heating element. In addition, some known electrically heated condensate pans, such as those having PTC heating elements, may have wattage limitations and must be electrically energized 100% of the time, which causes higher energy usage. Some condensate pans with heating element wattages above 2400 W may require dual control circuits, which increases complexity and unit costs.

Thus, there exists a need to solve these and other problems.

### SUMMARY

Disclosed herein are various embodiments of a condensate pan system configured to receive and evaporate condensate or other liquid arising from, for example, the operation of a refrigeration system. In one embodiment, a condensate pan system of the instant disclosure includes (i) a pan for receiving a liquid, the pan comprising a bottom wall, a pair of opposed side walls connected to the bottom wall, and a pair of opposed end walls connected to the bottom wall and respective side walls; (ii) an electric heating element for heating and evaporating the liquid, the electric heating element supported by the bottom wall; (iii) a reed switch comprising sealed electrical contacts, the reed switch including a float configured to react to a varying level of the liquid in the pan, the reed switch configured to close the electrical contacts when the float detects that the level of the liquid is equal to or exceeds a minimum predetermined height, and configured to open the electrical contacts when the float detects that the level of the liquid is below the minimum predetermined height; (iv) a thermostat positioned outside of the pan and proximate to the electric heating element, the thermostat being configured to disconnect electrical continuity inside the thermostat upon detecting that a temperature of one of the opposed end walls of the pan is equal to or exceeds a predetermined temperature, and configured to maintain electrical continuity inside the thermostat upon detecting that the temperature is below the predetermined temperature; and (v) a relay comprising sealed relay contacts configured to close upon detecting electrical continuity with the thermostat and the reed switch to maintain electrical power to the electric heating element, and configured to open upon detecting loss of electrical continuity with either the thermostat or the reed switch to disconnect electrical power to the electric heating element.

The pan may be rectangular, square, round, or any other shape. The electric heating element may be a tubular sheathed heating element. The electric heating element may be supported above the bottom wall by at least one L-shaped support. The support may include a base for connecting to the bottom wall and a slot for receiving the electric heating element. The Reed switch may be horizontally oriented, and the float may include a stainless steel or a polymer.

The pan may include at least one heat conduction device having a first end and a second end. The first end may be connected to the electric heating element and the second end may be connected to a liquid-side surface of the one of the opposed end walls. The thermostat may include a face and the face may be positioned against an outside surface of the one of the opposed end walls directly opposite the at least one heat conduction device.

The pan may include a housing attached to the one of the opposed end walls. The one of the opposed end walls may also be a wall of the housing. The housing may be configured to enclose the thermostat and the relay. The pan may include a terminal block for connecting the relay to line electrical power, and the housing may enclose the terminal block as well.

In another embodiment, a condensate evaporation system is disclosed, comprising: (i) a vessel for receiving a liquid, the vessel comprising a wall; (ii) an electric heating element positioned inside the vessel for heating and evaporating the liquid; (iii) a reed switch comprising sealed electrical contacts, the reed switch including a float configured to react to a varying level of the liquid in the vessel, the reed switch configured to close the electrical contacts when the float detects that the level of the liquid is equal to or exceeds a minimum predetermined height, and configured to open the electrical contacts when the float detects that the level of the liquid is below the minimum predetermined height; (iv) a thermostat positioned outside of the vessel and proximate to the electric heating element, the thermostat configured to disconnect electrical continuity inside the thermostat upon detecting that a temperature of the wall of the vessel is equal to or exceeds a predetermined temperature, and configured to maintain electrical continuity inside the thermostat upon detecting that the temperature is below the predetermined temperature; and (v) a relay comprising sealed relay contacts configured to close upon detecting electrical continuity with the thermostat and the reed switch to maintain electrical power to the electric heating element, and configured to open upon detecting loss of electrical continuity with either the thermostat or the reed switch to disconnect electrical power to the electric heating element.

The electric heating element may be a tubular sheathed heating element, and may be configured for contact with the liquid. The reed switch may be horizontally oriented. The float may include a stainless steel or a polymer.

The pan may include at least one heat conduction device comprising a first end and a second end. The first end may be connected to the electric heating element and the second end may be connected to the wall. The thermostat may include a face and the face may be positioned against an outside surface of the wall directly opposite the at least one heat conduction device. The pan may include a housing configured to cooperate with the wall to enclose the thermostat and the relay.

In another embodiment, a method of evaporating a liquid in a pan is disclosed, comprising: (i) positioning an electric heating element in the pan; (ii) positioning a reed switch comprising sealed electrical contacts, the reed switch including a float configured to react to a varying level of the liquid in the pan; (iii) positioning a thermostat outside of the pan and proximate to the electric heating element, the thermostat configured to disconnect electrical continuity inside the thermostat upon detecting a temperature that is equal to or exceeds a predetermined value, and configured to maintain electrical continuity inside the thermostat upon detecting that the temperature is below the predetermined value; (iv) positioning a relay comprising sealed relay contacts in electrical communication with the thermostat, the reed switch, and the electric heating element; (v) detecting the level of the liquid via the float; (vi) detecting electrical continuity with the thermostat; (vii) if the detected level of the liquid is equal to or exceeds a minimum predetermined height, and if electrical continuity with the thermostat exists, closing the relay contacts to electrically energize the electric heating element with electrical current to heat the liquid; and (viii) if the detected level of the liquid is below the minimum predetermined height or if electrical continuity with the thermostat does not exist, opening the relay contacts to electrically disconnect the electric heating element from the electrical current.

### BRIEF DESCRIPTION OF THE DRAWINGS

FIG. 1 is a top perspective of one embodiment of a condensate pan system of the instant disclosure.

FIG. 2 is a top plan view of the condensate pan system of FIG. 1.

FIG. 3 is top perspective view of the condensate pan system of FIG. 1 showing various aspects of the condensate pan system in an exploded arrangement.

FIG. 4 is a detailed top perspective view of various aspects of the condensate pan system shown in FIG. 3.

FIG. 5 is another detailed top perspective view of various aspects of the condensate pan system of FIG. 1 in an exploded arrangement.

FIG. 6 is a sectional view taken of the condensate pan system shown in FIG. 2.

FIG. 7 is another detailed top perspective view of various aspects of the condensate pan system of FIG. 1 in an exploded arrangement.

FIG. 8 is a detailed bottom perspective view of various aspects of the condensate pan system of FIG. 1 in an exploded arrangement.

FIG. 9 is another detailed bottom perspective view of various aspects of the condensate pan system of FIG. 1 in an exploded arrangement.

FIG. 10 is another detailed bottom perspective view of various aspects of the condensate pan system of FIG. 1 in an exploded arrangement.

FIG. 11 is another detailed top perspective view of various aspects of the condensate pan system of FIG. 1 in an exploded arrangement.

FIG. 12 is another detailed top perspective view of various aspects of the condensate pan system of FIG. 1 in an exploded arrangement.

FIG. 13 is another top perspective view of various aspects of the condensate pan system of FIG. 1 in an exploded arrangement.

FIG. 14 is another top perspective view of various aspects of the condensate pan system of FIG. 1 in an exploded arrangement.

FIG. 15 is a detailed top perspective view of various aspects of the condensate pan system shown in FIG. 14.

FIG. 16 is another detailed top perspective view of various aspects of the condensate pan system of FIG. 1 in an exploded arrangement.

FIG. 17 is another detailed bottom perspective view of various aspects of the condensate pan system of FIG. 1 in an exploded arrangement.

FIG. 18 is another detailed top perspective view of various aspects of the condensate pan system of FIG. 1 in an exploded arrangement.

FIG. 19 is another detailed top perspective view of various aspects of the condensate pan system of FIG. 1.

FIG. 20 is another detailed top perspective view of various aspects of the condensate pan system of FIG. 1.

FIG. 21 is a detailed top perspective view of various aspects of another embodiment of the condensate pan system of the instant disclosure.

FIG. 22 is an embodiment of an alarm or alert schematic for use in connection with the condensate pan system of FIG. 21.

FIG. 23 is a detailed top perspective view of various aspects of another embodiment of the condensate pan system of the instant disclosure.

FIG. 24 is an embodiment of an alarm or alert schematic for use in connection with the condensate pan system of FIG. 23.

FIG. 25 is a detailed top perspective view of various aspects of another embodiment of the condensate pan system of the instant disclosure.

FIG. 26 is an embodiment of an alarm or alert schematic for use in connection with the condensate pan system of FIG. 25.

FIG. 27 is an embodiment of a liquid conductivity sensor for use in connection with the condensate pan system of FIG. 25.

FIG. 28 is an embodiment of a smart relay for use in connection with the condensate pan of the instant disclosure.

FIG. 29 is a representative schematic showing different wireless communication pathways of an alarm or alert indication from the condensate pan of the instant disclosure.

### DETAILED DESCRIPTION

Although the figures and the instant disclosure describe one or more embodiments of a condensate pan system, one of ordinary skill in the art would appreciate that the teachings of the instant disclosure would not be limited to these embodiments. It should be appreciated that any of the features of an embodiment discussed with reference to the figures herein may be combined with or substituted for features discussed in connection with other embodiments in this disclosure.

Various embodiments of a condensate pan are disclosed herein. Condensate pans and condensate pan systems of the instant disclosure offer a number of advantages over known solutions, including enabling their use in or near refrigeration systems that are designed to use flammable or semi-flammable refrigerants, such as A2L and/or A3 class of refrigerants. In various embodiments, sealed electrical contacts on various components enable safe use of such components in contact with or in proximity to water or other liquid, and also enable safe use of such condensate pan systems in proximity with flammable and semi-flammable refrigerants, such as the A2L and/or A3 class of refrigerants. For example, various embodiments of condensate pan systems of the instant disclosure may be configured with a reed float switch (i.e., reed switch) having sealed electrical contacts. In various embodiments, condensate pan systems of the instant disclosure may be configured with a relay having sealed contacts therein.

In various embodiments, condensate pan systems of the instant disclosure may be configured with a water level sensing/detection device, such as one or more floats connected to a reed switch, to control the operation of one or more electrical switches or relays to connect or disconnect electrical current to energize or deenergize one or more electric heating elements positioned in, against, or in proximity to at least one liquid receptacle of such condensate pan systems. For example, in various embodiments, condensate pan systems of the instant disclosure may include a horizontally-mounted magnetic reed switch, and a stainless steel or polymer float. The float, which may be mechanically connected to the magnetic reed switch, may be configured to float on or near the surface of a liquid, such as water, that lies in the at least one liquid receptacle or pan portion of the condensate pan systems. In this way, the float is configured to rise or fall with the varying level of the water or other condensate in the at least one liquid receptacle or pan portion of the condensate pan system. As the float rises or falls according to the varying level of liquid in the at least one liquid receptacle or pan, activation/closing or deactivation/opening of the reed switch may occur thus enabling or disabling electrical current to energize or deenergize an electric heating element designed to cause evaporation of the liquid. In various embodiments, a single water level sensing/detection device can be configured to energize and/or deenergize a single electric heating element. In other embodiments, multiple water level sensing/detection devices may be deployed to correspondingly energize and/or deenergize multiple electric heating elements simultaneously or at different times with respect to one another, thus providing different wattage options at different times. In other embodiments, the water level sensing/detection device may include one or more liquid conductivity sensors and/or any device or system configured to detect water level in the condensate pan systems of the instant disclosure.

More particularly, when a liquid, such as water or other condensate, collects in the at least one liquid receptacle or pan and rises to a level sufficient to activate/close the reed switch, then the activated/closed reed switch may be configured to close an electrical circuit on which a relay with sealed contacts is disposed to provide electrical current to the electric heating element. As mentioned above, the electric heating element is configured to heat the liquid to a temperature sufficient to evaporate the liquid. When the liquid in the at least one liquid receptacle or pan falls due to evaporation or other reasons to a level sufficient to inactivate/open the reed switch, then the inactivated/open reed switch creates an open electrical circuit that disconnects electrical continuity with the relay to disconnect electrical current to the electric heating element. Advantageously, the aforementioned reed switch and relay configured with sealed contacts may permit these components to be used in applications that use a flammable or semi-flammable refrigerant, such as refrigeration systems, because the sealed contacts vastly diminish the risk that an electrical arc from the contacts could ignite the refrigerant even if the refrigerant is in an ignitable concentration proximate to the reed switch and/or the relay. Under LZGH-2 and-8 entitled, “Flame Arrest-protected Components for Use in Refrigeration and Air-conditioning Equipment Employing A2L Refrigerants Certified in Canada,” UL has approved various relay models manufactured by American Zettler, Inc. for use in refrigeration systems employing A2L refrigerants. For example, American Zettler, Inc. Model AZ2280 is a power relay available with sealed internal switch contacts that UL has approved for use in refrigeration systems employing A2L refrigerants, and would be a suitable model for use in connection with the condensate pan systems of the instant disclosure. In other embodiments, the water level sensing/detection device may include a liquid conductivity sensor instead of the aforementioned one or more floats connected to a reed switch.

In various embodiments, condensate pan systems of the instant disclosure may optionally include a thermostat, such as a bimetal thermostat, positioned near or in contact with the at least one liquid receptacle or pan portions of such condensate pan systems. In some embodiments, the thermostat may be mounted to a side of the at least one liquid receptacle or pan in proximity to one or more legs extending from the at least one liquid receptacle or pan and/or near or within an electrical control box or housing of the at least one liquid receptacle or pan. In some embodiments, the thermostat may be positioned on or near a wall of the at least one liquid receptacle or pan directly opposite the point where a heated portion of the electric heating element lies on the other side of the wall of the at least one liquid receptacle or pan. In various embodiments, the thermostat is configured to open the electrical circuit upon detecting a predetermined high temperature associated with heat emitted from the electric heating element, and to close the electrical circuit upon detecting a predetermined low temperature associated with heat emitted from the electric heating element. In various embodiments, the predetermined high temperature is 110° C. to ensure that the temperature of the pan wall does not climb past 150° C. after disconnecting electrical power to the electric heating element. In other embodiments, the predetermined high temperature may be more or less than 110° C. depending on the thermostat manufacturer and model, the wattage of the electric heating element, the position of the electric heating element relative to a wall of the at least one liquid receptacle or pan, and the position of the thermostat relative to the wall and/or the electric heating element itself. Thermostat Model KSD301A A323, available from American Zettler, Inc., is an example of a bimetal thermostat that may be suitable for use in connection with condensate pan systems of the instant disclosure. In other embodiments, a switch, such as a limit switch or other on/off switch, in combination with a temperature sensor, such as a thermocouple, and a controller comprising a processor and memory may accomplish the same function to detect a threshold temperature to safely electrically energize/deenergize the electric heating element in accordance with the teachings of the instant disclosure.

In various embodiments, condensate pan systems of the instant disclosure may include one or more electric heating elements. The one or more electric heating elements may comprise a tubular heating element comprising an electrically resistive wire (resistance wire). The electrically resistive wire may comprise a nickel alloy, such as nichrome, that is encased in a suitable insulator, such as a densely-packed magnesium oxide powder, all of which may be covered by a tubular metallic sheath. Electric heating elements of this construction type are suitable for connecting to a reed float switch as part of the electrical circuit to connect/disconnect electrical current to the one or more electric heating element.

The one or more electric heating elements may be positioned in close proximity to an inner surface of a wall (i.e., the liquid side of the wall) of the at least one liquid receptacle or pan to enable a thermostat positioned on an outer surface of that wall (i.e., the non-liquid side of the wall) to quickly detect a temperature of the wall that is heated by radiation and/or convection by the one or more electric heating elements, which heat is conducted through the wall and detected by the thermostat. In some embodiments, the distance between the outer sheath of at least one pass of the one or more electric heating elements to the inner wall surface of the at least one liquid receptacle or pan is approximately 0.25″ to about 0.50″. A distance of this approximate magnitude allows a reasonable likelihood that the thermostat would react to changes in wall temperature of the at least one liquid receptacle or pan to safely disconnect power to prevent the wall temperature of the at least one liquid receptacle or pan from exceeding 150° C. The distance may be higher (for example, about 0.75″) or lower (for example, about 0.10″) depending on one or more of (i) the wattage of the one or more electric heating elements, (ii) the coefficient of thermal conductivity of the selected pan wall material, (iii) the size and/or volume of the at least one receptacle or pan, (iv) the placement of the thermostat relative to the one or more electric heating elements, and (v) the sensitivity of the thermostat to detect and react (i.e., by opening or closing an electrical circuit) to detected temperature changes of the wall. In some embodiments, use of a relatively low wattage electric heating element may never trigger the thermostat to activate, even if the heating element is not submerged with liquid. In other embodiments, use of a relatively high wattage electric heating element may easily trigger activation of the thermostat to disconnect electrical power to the heating element to ensure that the wall of the at least one liquid receptacle or pan does not exceed 150° C. The thermostat may be set to open the electrical circuit when it detects 110° C. to allow for 40° C. of overshoot that may occur from the momentum of heat generated from the one or more electric heating elements as it cools down.

To enhance the response time or to ensure activation of the thermostat so as to minimize or control overshoot of the temperature of the wall of the at least one receptacle or pan to not exceed 150° C., one or more heat transfer devices may be disposed as described below to provide a heat conduction path from the sheath of the one or more electric heating elements directly to the wall of the at least one receptacle or pan. By employing one or more heat transfer devices, the use of relatively higher wattage heating elements for a given pan size may help ensure that the wall of the at least one receptacle or pan does not exceed 150° C.

For example, the one or more heat transfer devices may be connected to the outer sheath of the one or more electric heating elements on one end, and to an inner surface of a wall of the at least one receptacle or pan. The one or more heat transfer devices may be snapped onto the outer sheath of the one or more electric heating elements.

The one or more heat transfer devices may comprise a metallic heat transfer clip configured with spring temper, each of which extending from the one or more electric heating elements. In other embodiments, the one or more heat transfer devices may be any configuration and may be made of any material consistent with the purpose described herein. The one or more heat transfer devices may be configured to make contact with an inner surface or side of the wall of the at least one liquid receptacle or pan at a location directly opposite the location of the face of the thermostat that is mounted in proximity to or on the other, outer surface or side of the wall. In this way, heat may flow via conduction from the electric heating element to the heat transfer device, via conduction from the heat transfer device to the pan wall, and via conduction from the pan wall to the thermostat to enable pseudo-direct detection of temperature of heat emitted from the electric heating element.

For example, should the float or relay fail in operation, thus causing the heating element to remain electrically energized when the liquid level is below a desired level in the at least one liquid receptacle or pan (such as below a surface of the heating element when it otherwise is desired to be totally submerged when energized), the one or more heat transfer devices may transfer heat directly to the wall or surface on which the thermostat is mounted. In response, the thermostat may be configured to open the electrical circuit upon detecting a predetermined high temperature associated with heat emitted from the heating element, thus acting as a secondary safety device to ensure that the heating element does not itself cause or create a separate fire hazard. In various embodiments, the predetermined high temperature is 150° C., which coincidentally is the maximum temperature limit set forth in UL Standard UL-471 for the surface temperature of the liquid receptacle or pan. Advantageously, in various embodiments the thermostat may be configured to react and disconnect electrical power to the heating element after water or other liquid falls below the top surface of an energized electric heating element or any other predetermined level in the liquid receptacle before any surface of the liquid receptacle or pan reaches 150° C. In this way, inclusion of a thermostat may provide an additional measure of safety to ensure that the pan wall does not exceed 150° C., regardless of whether the reed float switch detects that the level of the liquid is below the minimum predetermined height to disconnect electrical power to the one or more electric heating elements.

In various embodiments, the one or more electric heating elements may be suspended above the floor of the at least one liquid receptacle or pan at a desired height above the floor using one or more supports. The one or more supports may be configured to secure the electric heating element to the at least one liquid receptacle or pan.

In various embodiments, condensate pan systems of the instant disclosure may be configured in different sizes and shapes, run on 120V, 208V, or 240V electrical power sources, and have heating element wattages that range from about 200 W to about 3000 W on a single electrical circuit.

In various embodiments, condensate pan systems of the instant disclosure may include an alarm or alert system comprising a “smart” relay or controller and a second water level sensing/detection device for communicating an error/malfunction status or a high water indication, for example, to one or more remote computers, servers, and/or mobile devices via Wi-Fi or any other suitable wireless protocol, such as Bluetooth.

Software applications operating on such one or more remote computers, servers, and/or mobile devices may provide one or more visual or audio alerts, notifications, or messages to a user, including (i) audio noise, alarms, rings, chirps and the like, (ii) text messages, emails, and the like, and (iii) visual indicators, highlights, flashing or blinking lights, and the like. Such one or more visual or audio alerts, notifications, or messages may be provided simultaneously or at different times to a user. For example, an LED indicator on a user's mobile phone may be caused to illuminate in a particular color or pattern to alert the user of an error/malfunction status or a high water indication. Should the alert condition remain active for a predetermined time, the software application may be configured to cause the LED indicator to illuminate in a different color or pattern to indicate a more serious or prolonged alarm status. In addition or alternatively, the software application may be configured to cause emission of an audible noise, alarm, ring, and/or chirp, for example, by or from such remote one or more remote computers, servers, and/or mobile devices simultaneously with any such visual alerts, notifications, or messages should the alert condition remain active for a predetermined period of time.

The second water level sensing/detection device may be configured to operate in conjunction with a first water level sensing/detection device. For example, the second water level sensing/detection device may operate to sense or detect water level that reaches a second height that is different than a first height for which a first water level sensing/detection may be configured to detect, where the first height corresponds to the desired height for energizing and/or deenergizing the one or more electric heating elements, and where the second height corresponds to the desired height to activate the alarm or alert system.

The second water level sensing/detection device may be configured to be mounted to a side wall near the top of the pan. The second water level sensing/detection device may include any water level sensing/detection device or system configured to detect level of water in the condensate pan systems of the instant disclosure. For example, the second water level sensing/detection device may include any of (i) a second one or more floats connected to a second one or more reed switches, (ii) one or more liquid conductivity sensors, (iii) a dual float water level sensing/detection device configured to sense water levels at two different heights using a single device, or any other suitable liquid level sensing device or system.

The alarm or alert system may be configured to operate when the secondary water level sensing/detection device detects water at the second height. The alarm or alert system may be configured to report an indication to, for example, a remote user that water in the pan is nearing overflow in the pan. Such pending or actual overflow may be caused by malfunction of one or more components of the condensate pan systems of the instant disclosure, including a malfunctioning first water level sensing/detection device, one or more electric heating elements, a thermostat, one or more electrical switches or relays, or any combination of these.

The dual float water level sensing/detection device may be configured to detect and react to a predetermined first water level height and a predetermined second water level height. For example, when rising water tracked by a lower float of the dual float water level sensing/detection device reaches a first water level height, the dual float water level sensing/detection device may be configured to activate/close a lower float reed switch thus enabling electrical current to energize an electric heating element designed to cause evaporation of the liquid. As the water evaporates and the water level falls below the first water level height, the lower float likewise lowers to open the reed switch thus deenergizing the electric heating element. Should the water rise for any reason and reach a predetermined second height above the predetermined first water level height, as tracked by a higher float of the dual float water level sensing/detection device, the dual float water level sensing/detection device may be configured to activate/close an upper float reed switch thus enabling electrical current to energize and activate an alarm or alert system of the instant disclosure. Should the water recede below the predetermined second height, the dual float water level sensing/detection device may be configured to deactivate/open the upper float reed switch thus deenergizing and deactivating the alarm or alert system of the instant disclosure. When activated, the alarm or alert system may be configured to report the pending liquid overflow status of the condensate pan systems of the instant disclosure.

In various embodiments, a suitable smart relay is available from DieseRC, such as its 1 channel Wi-Fi smart switch with passive output relay module available from Amazon.com. In various embodiments, a suitable dual float water level sensing/detection device is available from Soweytech.com. These devices and their functionality are incorporated by reference herein in their entirety.

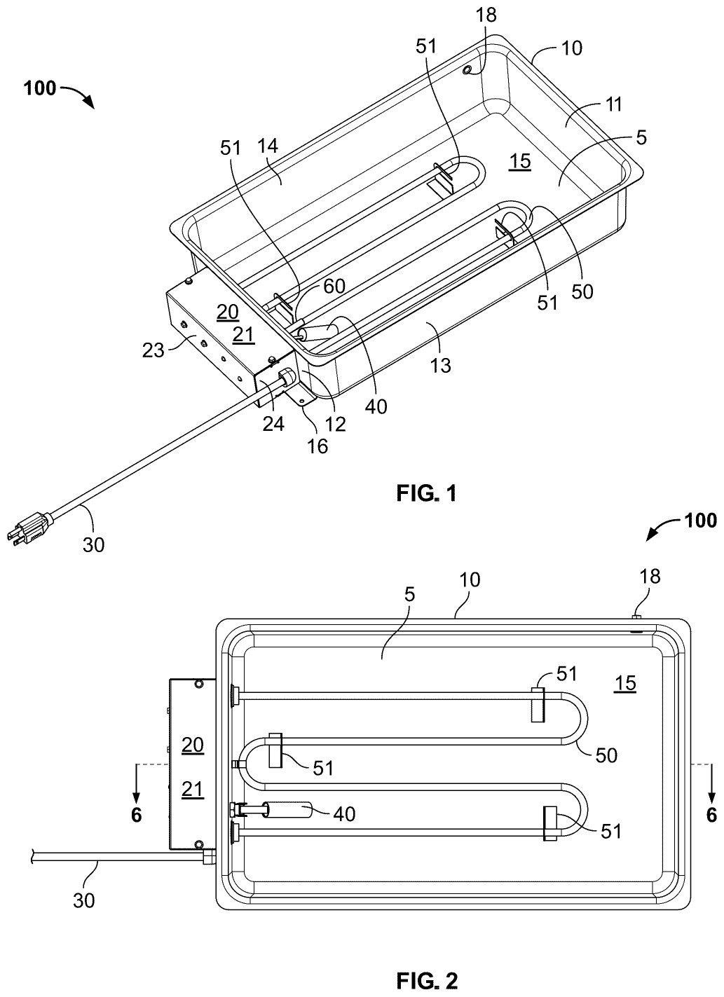

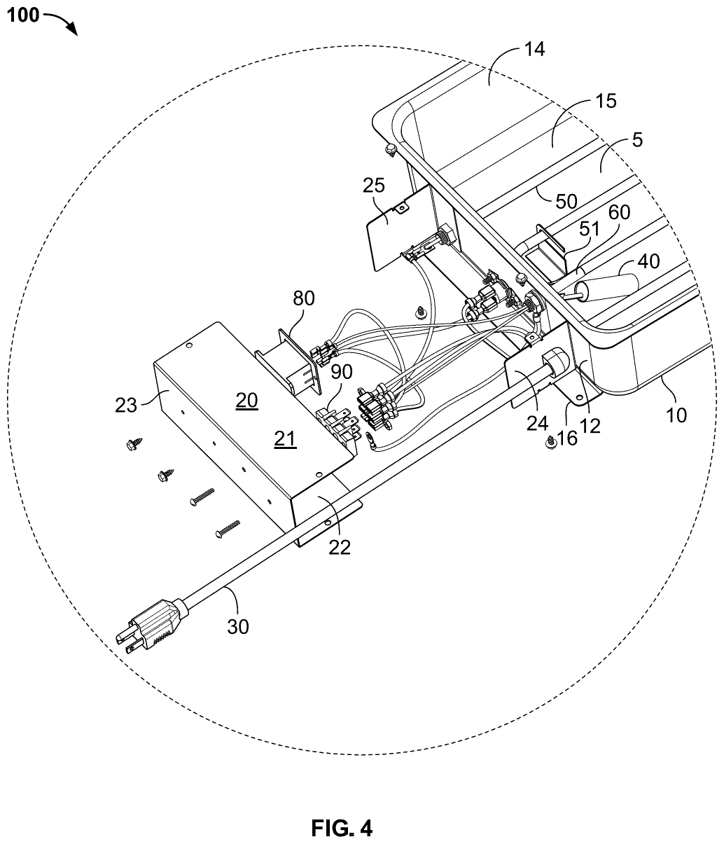

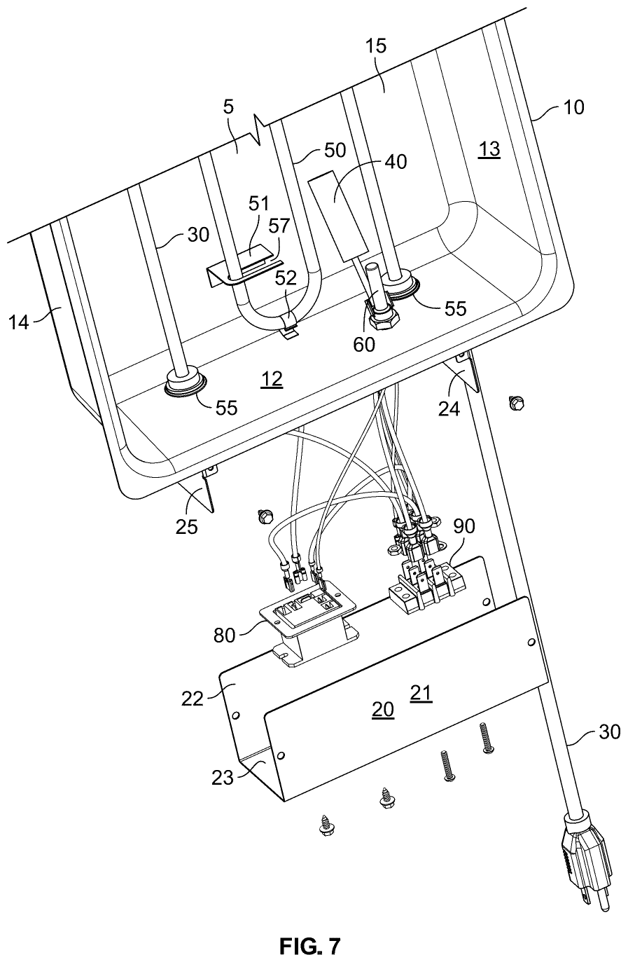

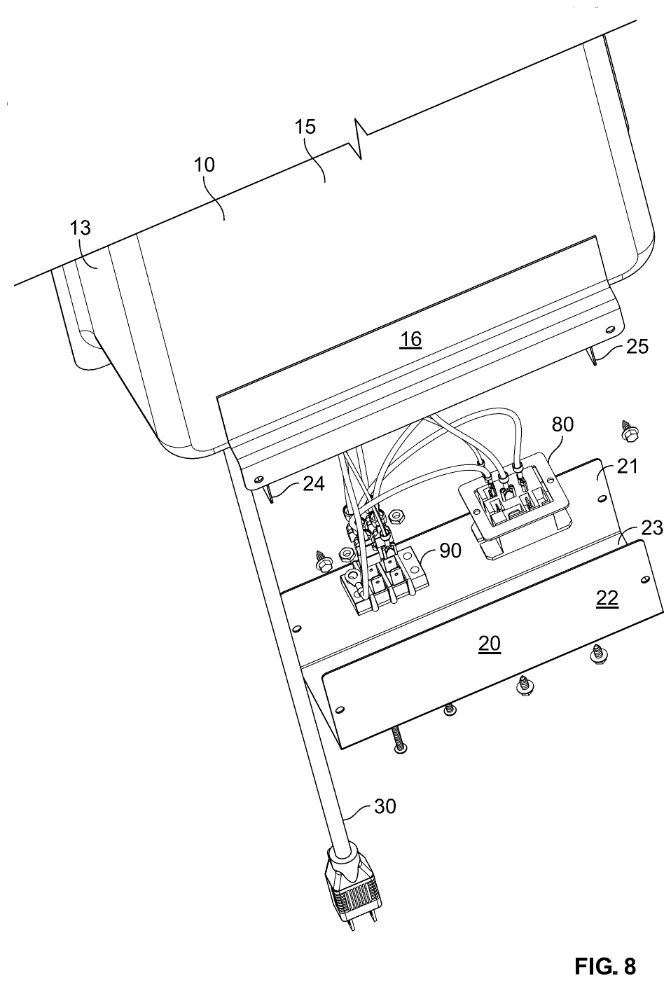

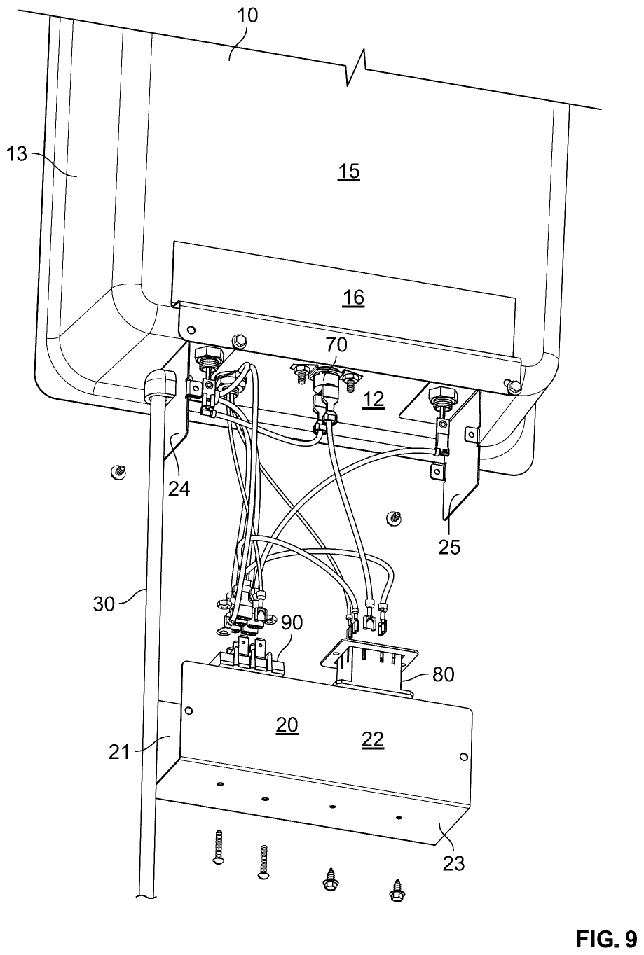

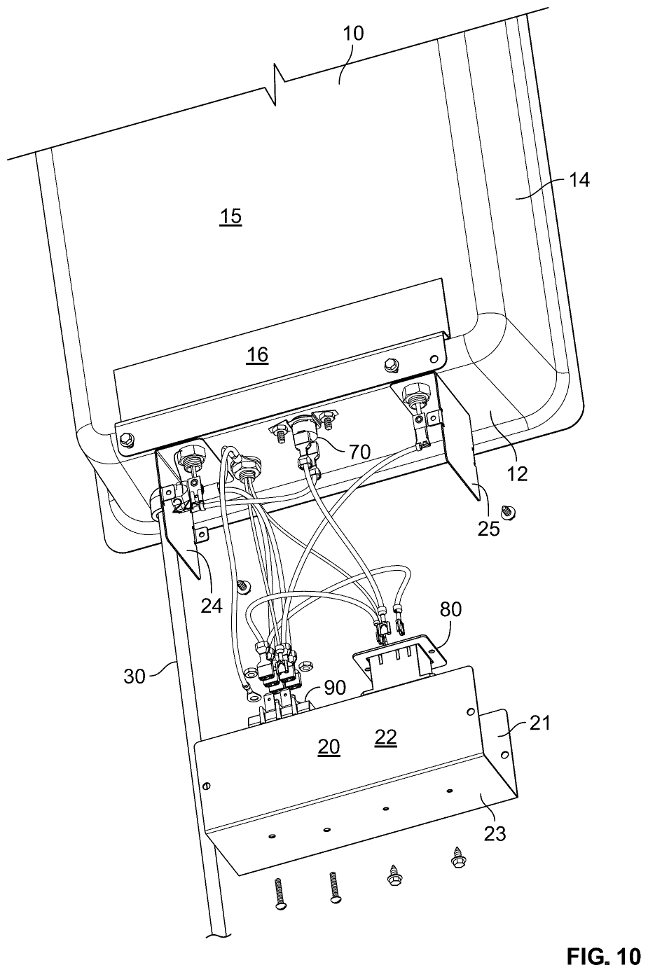

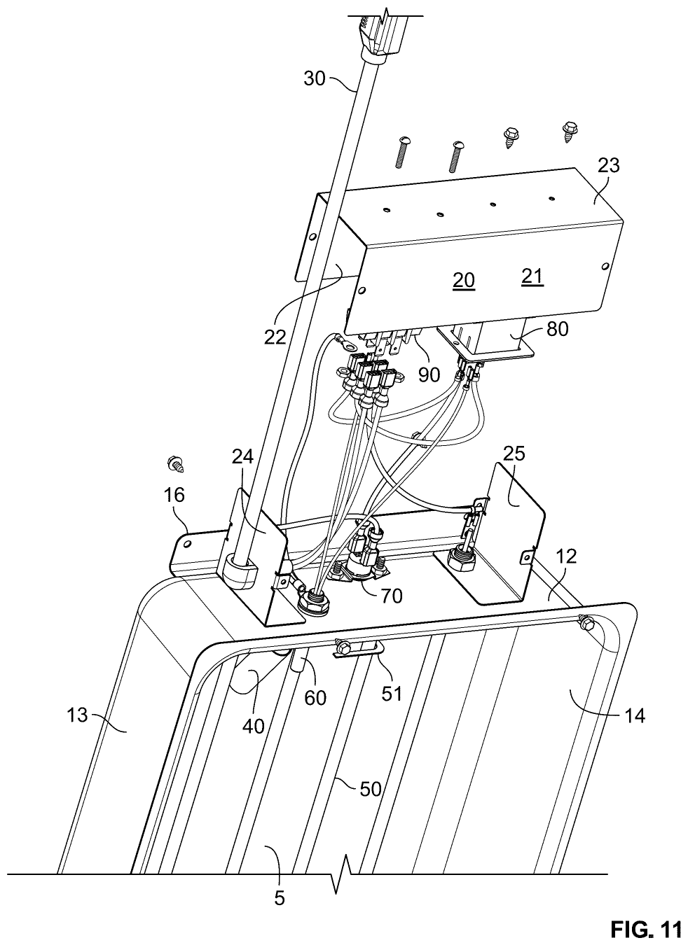

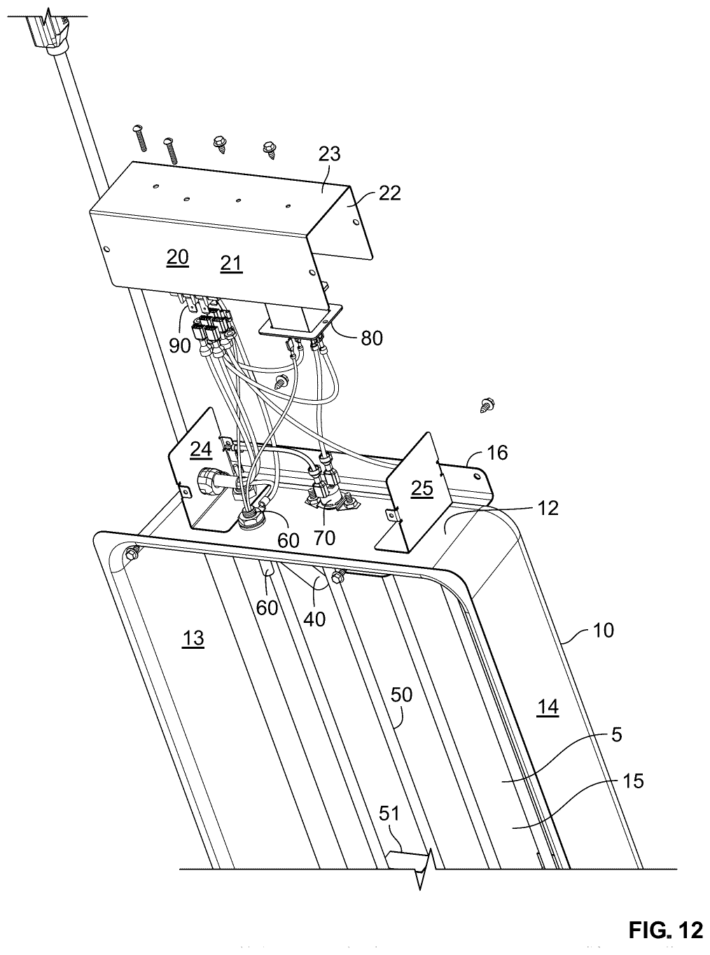

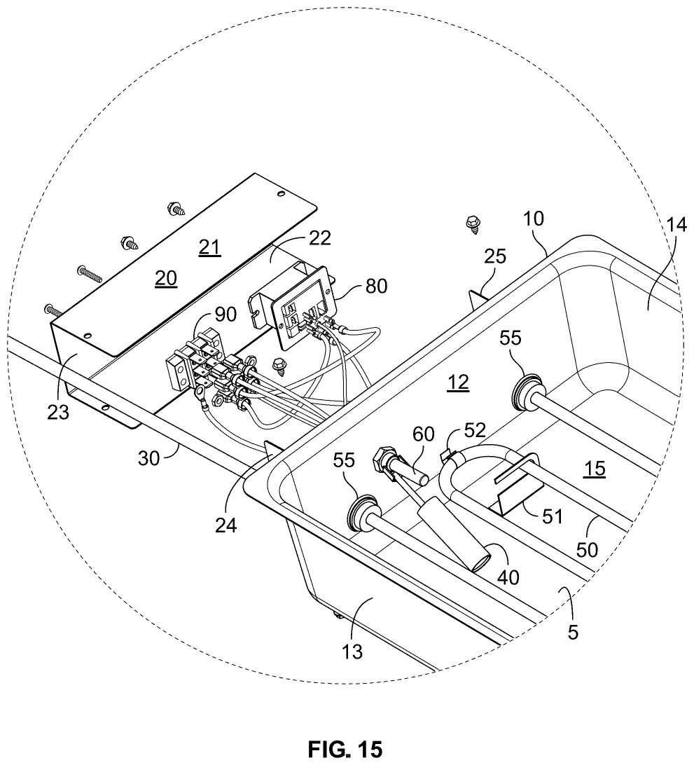

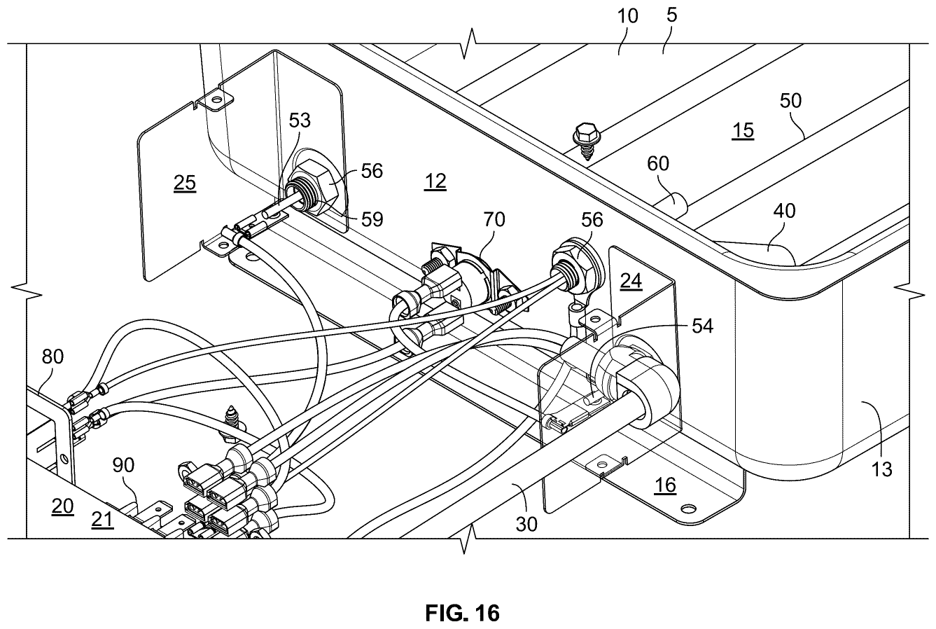

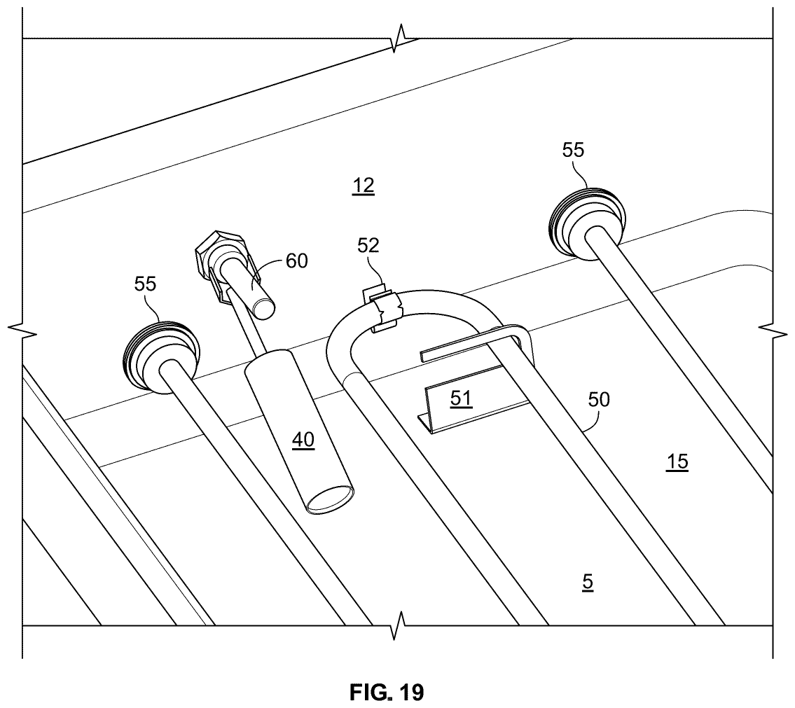

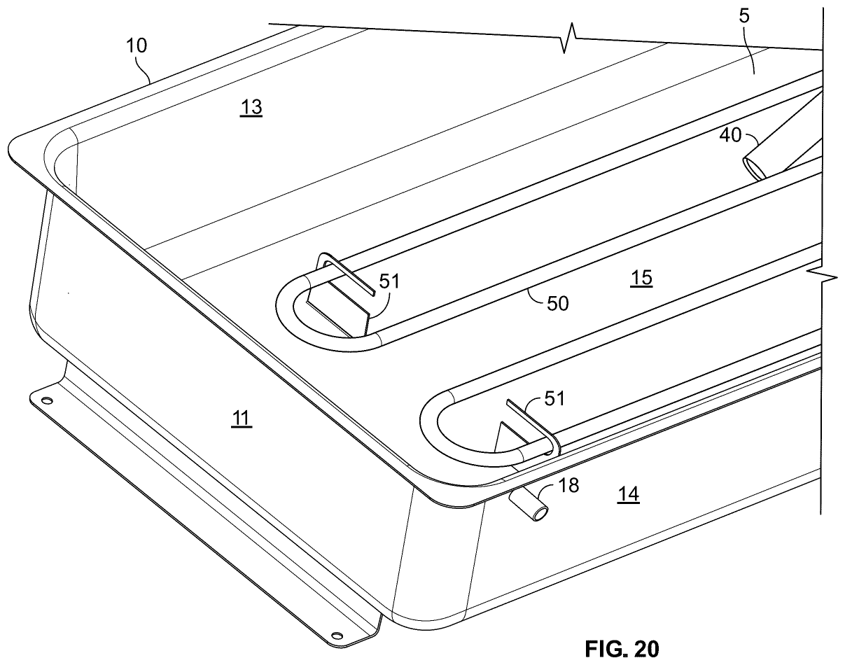

Turning now to the drawings and to FIGS. 1-20 in particular, there are shown various aspects of a representative condensate pan system 100 of the instant disclosure. As illustrated in FIG. 1, representative condensate pan system 100 includes pan 10, control housing 20, power cord 30, float 40, electric heating element 50, reed switch 60, thermostat 70, relay 80, and terminal block 90.

Pan 10 is configured to collect a liquid, such as water, and to evaporate that liquid. Pan 10 includes end walls 11,12, side walls 13,14, bottom wall 15, and lip 19, all of which cooperate to form liquid receptacle 5. In the embodiment shown in the figures, end walls 11,12 are shorter than side walls 13,14. In other embodiments, end walls 11,12 are either the same length as or longer than side walls 13,14. In the embodiment shown in the figures, the vertical height of end walls 11,12 and of side walls 13, 14 is shorter than the length of any of these items.

Pan 10 may be made from any suitable material to form liquid receptacle 5. In the embodiment shown in the figures, pan 10 comprises a sheet metal, such as a stainless steel. In other embodiments, pan 10 may comprise a plastic. Pan 10 including end walls 11,12, side walls 13,14, bottom wall 15, and lip 19 may comprise a single sheet of stainless steel pressed or formed into the shape shown in the figures. In other embodiments, one or more of end walls 11,12, side walls 13,14, bottom wall 15, and lip 19 may be welded together or otherwise fastened together from two or more separate pieces.

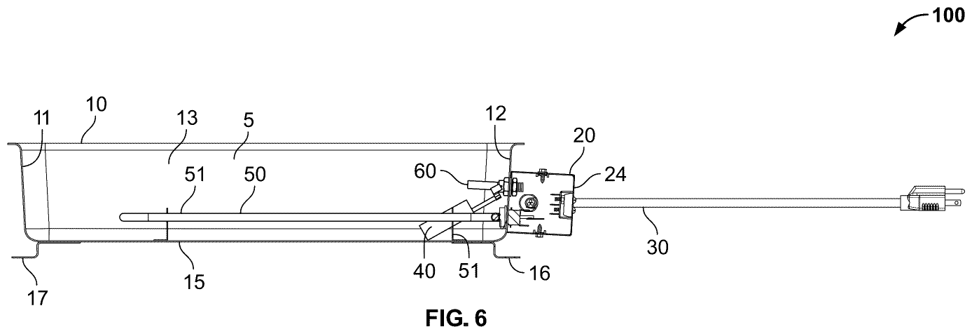

As best shown in FIGS. 6, 8, and 20, pan 10 of condensate pan system 100 of the instant disclosure includes S-shaped legs or supports 16,17 connected to bottom wall 15 and extending along the length of respective end walls 11,12. Supports 16, 17 may comprise a sheet metal, such as a stainless steel. In other embodiments, supports 16,17 may comprise a plastic. Supports 16, 17 may be affixed to bottom wall 15 by welding or other suitable attachment means. The length, quantity, and geometry of supports 16, 17 may vary from that shown in the drawings without departing from the scope of the instant disclosure.

As best shown in FIGS. 1, 3, and 20, pan 10 may also include overflow port 18 to allow water other liquid to overflow in a controlled manner if the water or other liquid collects in pan 10 rises sufficient to reach overflow port 18. Overflow port 18 may be made from the same material as end walls 11,12, side walls 13,14, bottom wall 15, and lip 19. Overflow port 18 may comprise an aperture through one of the vertical walls of pan 10, such as side wall 14.

Turning again to FIG. 1, condensate pan system 100 of the instant disclosure includes electric heating element 50 positioned inside concave liquid receptacle 5 of pan 10. Electric heating element 50 is configured to be submerged under any liquid collected in a liquid receptacle 5 of pan 10 to enable direct heating and evaporation of the liquid. Electric heating element 50 may be a tubular heating element comprising an electrically resistive wire (resistance wire) comprising a nickel alloy that is encased in a suitable insulator, such as a densely-packed magnesium oxide powder, all of which is covered by a tubular metallic sheath. In other embodiments, electric heating element 50 may comprise any profile consistent with the purposes set forth herein. Electric heating element 50 may extend from one end to another in, for example, a planar, zig-zag manner to cover a designed amount of the surface area of bottom wall 15. When exposed to an electrical current, the resistance wire releases heat that is usable to heat the water or other liquid collected by pan 10 to a temperature sufficient to evaporate the liquid. In other embodiments, electric heating element 50 may be linear, U-shaped, S-shaped, W-shaped, nonplanar, or any other desired planform or shape sufficient to heat water or other liquid as desired inside liquid receptacle 5. In some embodiments, electric heating element 50 is configured to lie outside liquid receptacle 5 while being configured to heat pan 10 sufficient to evaporate water or other liquid lying inside liquid receptacle 5.

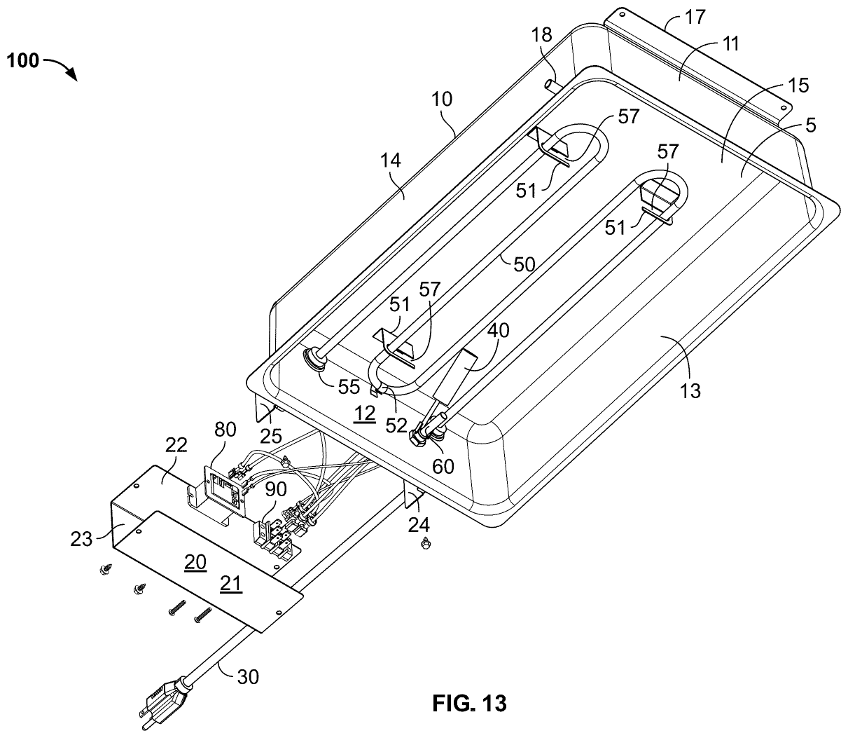

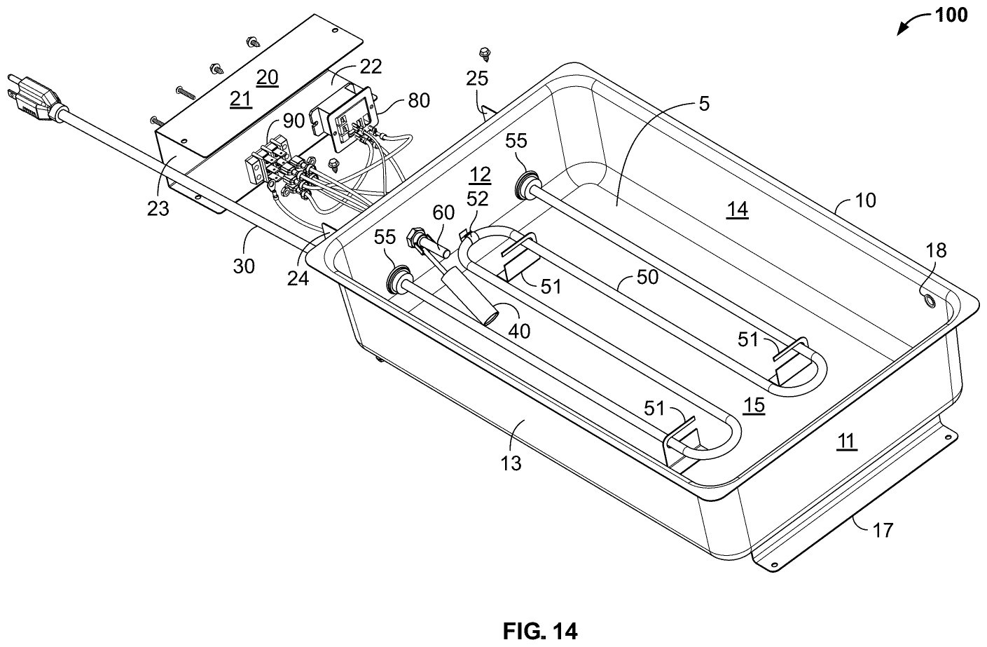

As best shown in FIG. 13, electric heating element 50 is configured to be supported and suspended above bottom wall 15 by one or more supports 51. In the embodiment shown in the figures, supports 51 are configured to be secured to bottom wall 15 and to extend vertically therefrom. Supports 51 may comprise a sheet metal, such as a stainless steel, and may comprise an L-shaped profile with the bottom portion of the “L” secured via welding or other suitable means to bottom wall 15 and with the upper portion of the “L” extending vertically from the bottom portion of the “L.” Supports 51 may be configured with spring temper. In elevation view, supports 51 may each include a horizontally oriented slot 57 in the upper portion of the “L” to receive and secure a portion of the electric heating element 50. To help prevent side-to-side motion while suspending electric heating element 50 above bottom wall 15 at least two supports 51 may be secured to bottom wall 15 and arranged with the open end of respective slots 57 toward one another or with the open end of respective slots 57 oriented opposite one another and with the slots 57 generally perpendicular to respective side walls 13,14. As best shown in FIG. 14, a third support 51 may be disposed with its slot 57 oriented in the same direction as one of the other two slots 57. To prevent motion of electric heating element 50 toward and away end walls 11,12, electric heating element 50 may be secured to end wall 11 as discussed more fully below. As best shown in FIGS. 13-15, electric heating element 50 may additionally be supported by heat transfer clip 52 that is itself attached, for example by welding, to end wall 12 on the liquid receptacle side of end wall 12 to enable conductive heat transfer from electric heating element 50 to end wall 12 and from end wall 12 to thermostat 70 as discussed herein.

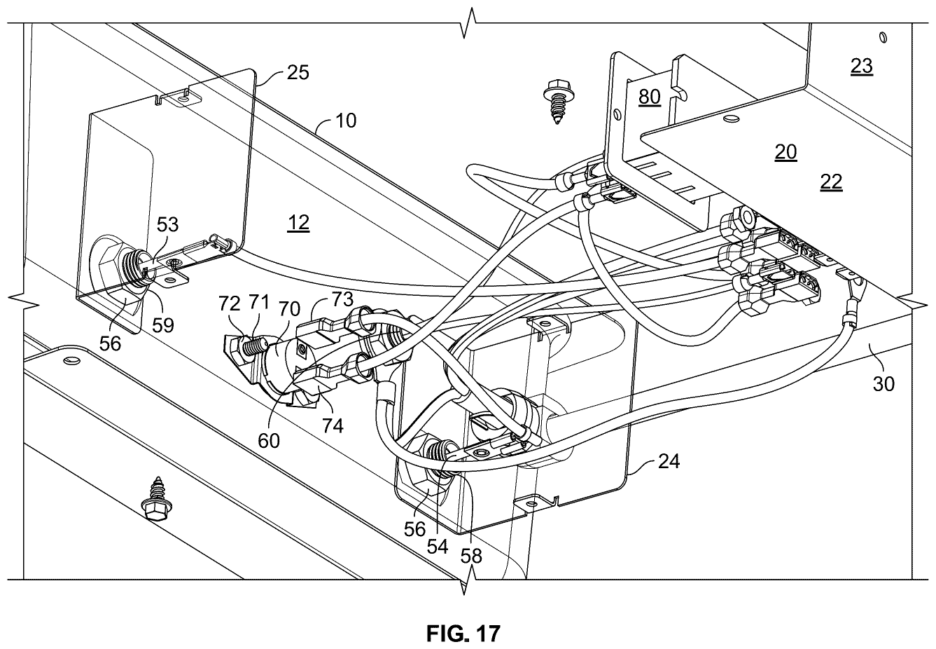

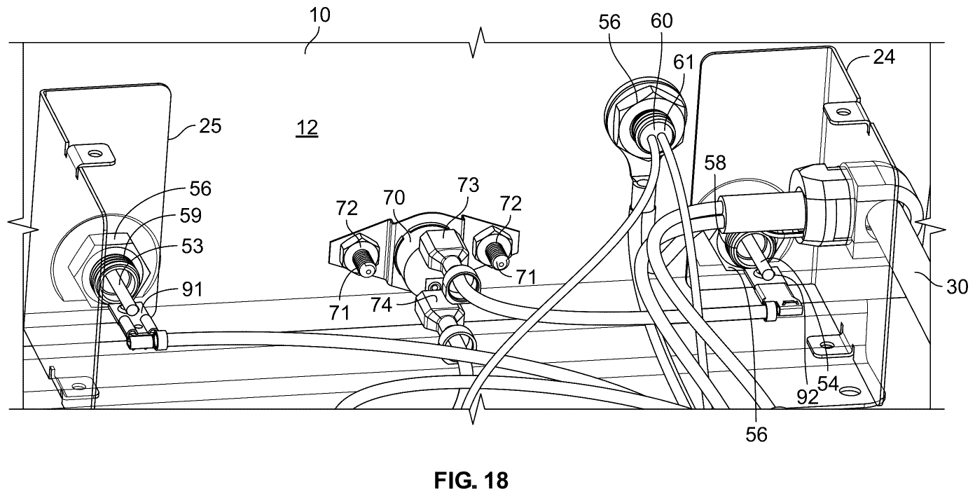

As best shown in FIGS. 17-18, respective terminal ends 58,59 comprising respective electrical conductors 54,53 of electric heating element 50 may extend through respective opposed apertures in end wall 12. To secure electric heating element 50 to end wall 12 and to prevent leakage through the apertures, seals 55 may be disposed to seal terminal ends 58,59 against end wall 12 on the liquid receptacle side of end wall 12 using nuts 56 that are threaded onto terminal ends 58,59 on the opposite side of end wall 12 to secure and seal the terminal ends 58,59 in place. As shown in FIGS. 17-18, nuts 56 may serve the dual purpose of also securing control housing brackets 24,25 to the outside surface of end wall 12. Respective ends of the resistance wire of electric heating element 50 may be connected to respective electrical conductors 53,54, and electrical conductors 53,54 may extend from terminal ends 58,59 to connect with terminal junctions 91,92.

As best shown in FIG. 18, thermostat 70 may be secured to the outside surface of end wall 12 via threaded studs 71 and nuts 72 such that the face of the bimetal portion is positioned against the outside surface of end wall 12. In various embodiments, thermostat 70 may be configured as a mechanical bi-metal thermostat that is configured to open and close an electrical circuit across terminals 73,74 depending on the detected temperature of the end wall 12, which temperature is conducted to end wall 12 by heat transfer clip 52 positioned directly opposite thermostat 70 on the inside surface of end wall 12. In this way, should the float or relay fail in operation, thus causing electric heating element 50 to remain electrically energized when the liquid level is below a desired level in the at least one liquid receptacle 5 (such as below a surface of the heating element when it otherwise is desired to be totally submerged when energized), heat transfer clip 52 may transfer heat directly by conduction to end wall 12 from electric heating element 50. In response, thermostat 70 is configured to open an electrical circuit upon detecting a predetermined high temperature associated with heat emitted from electric heating element 50, thus acting as a secondary safety device to ensure that electric heating element 50 does not itself cause or create a separate fire hazard. In various embodiments, the predetermined high temperature is 150° C., which coincidentally is the maximum temperature limit set forth in UL Standard UL-471 for the surface temperature of the liquid receptacle or pan. In other embodiments, the predetermined high temperature is any desired temperature setting. Thermostat Model KSD301A A323, available from American Zettler, Inc., is an example of a bimetal thermostat that may be suitable for use in connection with condensate pan system 100 of the instant disclosure.

As best shown in FIGS. 6 and 18-19, reed switch 60 comprising at least two ferromagnetic contact blades may extend through an aperture in end wall 12 and be secured to end wall 12 using nut 56 that is threaded onto terminal end 61 on the opposite side of end wall 12. Although not shown, a seal may be disposed between the reed switch 60 on the receptacle side of end wall 12 and end wall 12 to prevent leakage of liquid therebetween. Terminal end 61 may be grounded via a ground wire that extends from terminal end 61 to terminal block 90. Reed switch 60 may be horizontally oriented when installed on liquid receptacle 5 as shown in the figures. Float 40 may be connected to reed switch 60 and configured to float on or near the top surface of liquid in liquid receptacle 5 and to respond to changes in the level of liquid in receptacle 5. As the level of liquid in receptacle 5 rises and falls, float 40 rises and falls, which causes reed switch 60 to close and open electrical internal contacts inside a moisture sealed portion of reed switch 60 to close and open an electrical circuit to energize and deenergize electric heating element 50. For example, when the level of liquid in receptacle 5 rises to a predetermined upper limit, then reed switch 60 is configured to close the electrical circuit to energize electric heating element 50. Likewise, when the level of liquid in receptacle 5 recedes to a predetermined lower limit, then reed switch 60 is configured to open the electrical circuit to disconnect electrical power to electric heating element 50. In various embodiments, the ferromagnetic contact blades of reed switch 60 are sealed so as to prevent moisture on the contact blades to allow use of the reed switch 60 in or near liquid environments. Reed switch 60 configured with sealed contacts may also permit reed switch 60 to be used in applications that use a flammable or semi-flammable refrigerant, such as refrigeration systems, because the sealed contacts vastly diminish the risk that an electrical arc from the contacts could ignite the refrigerant even if the refrigerant is in an ignitable concentration proximate to reed switch 60.

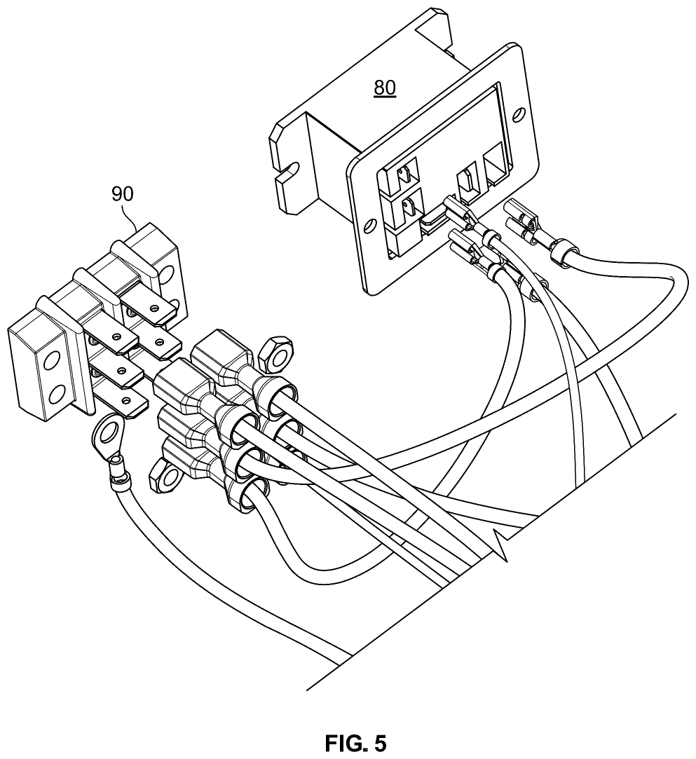

Turning to FIG. 5 there is shown a representative example of relay 80 and terminal block 90 of the instant disclosure. Advantageously, relay 80 may be configured with sealed switch contacts to permit condensate pan systems of the instant disclosure to be used in applications that use a flammable or semi-flammable refrigerant, such as refrigeration systems, because the sealed contacts vastly diminish the risk that an electrical arc from the contacts could ignite the refrigerant even if the refrigerant is in an ignitable concentration proximate to relay 80. Under LZGH-2 and-8 entitled, “Flame Arrest-protected Components for Use in Refrigeration and Air-conditioning Equipment Employing A2L Refrigerants Certified in Canada,” UL has approved certain relay models manufactured by American Zettler, Inc. for use in refrigeration systems employing A2L refrigerants. For example, American Zettler, Inc. Model AZ2280 is a power relay available with sealed internal switch contacts that UL has approved for use in refrigeration systems employing A2L refrigerants, and would be a suitable model for use in connection with the condensate pan system 100 of the instant disclosure.

As best shown in FIGS. 5, 16, and 18, terminal block 90 cooperates with relay 80 to provide electrical power from power cord 30 to electric heating element 50 via reed switch 60, and float 40, subject to a predetermined temperature limit according to the temperature cutoff limit of thermostat 70.

To energize electric heating element 50 to heat liquid in liquid receptacle 5 to cause the liquid to evaporate, electrical current from power cord 30 is routed to a spade terminal on terminal block 90 via a hot wire, and a hot wire connects another spade terminal on terminal block 90 to a spade terminal on relay 80. Relay 80 and reed switch 60 will both be activated/closed when float 40 rises due to reaching a desired high liquid level. In that event, electrical current is routed from a hot wire from terminal block 90 to reed switch 60 and then to relay 80. Electrical current from another spade terminal on terminal block 90 is routed by a hot wire connected to a spade terminal on thermostat 70. So long as thermostat 70 does not detect a predetermined high temperature, thermostat 70 will maintain the circuit across thermostat 70 and transfer electrical current to another spade terminal of thermostat 70. A hot wire from that spade terminal is connected to terminal junction 92 of electric heating element 50. Electrical current is transmitted to conductor 54 and then to the resistance wire of electric heating element 50 to create and emit heat energy due to relatively high electrical resistivity of the resistance wire. Electrical current continues to conductor 53 of electric heating element 50 and then to terminal junction 91. A hot wire transmits electrical current back to a spade terminal on terminal block 90. The circuit is completed by connecting a common wire of power cord 30 to another spade terminal in the terminal block 90.

If the level of liquid falls below a desired level (as tracked by float 40) sufficient to open reed switch 60, then an open circuit occurs and electrical current ceases to flow to electric heating element 50, thus turning electric heating element 50 off. If either reed switch 60 or float 40 fail during operation of electric heating element 50, thus causing electric heating element 50 to remain electrically energized when the liquid level is below a desired level in liquid receptacle 5, then heat transfer clip 52 may transfer heat directly to end wall 12 from electric heating element 50 to the thermostat 70 on the other side of end wall 12. In response, thermostat 70 is configured to open the electrical circuit as described above, thus ceasing the flow of electrical current to electric heating element 50 to turn electric heating element 50 off.

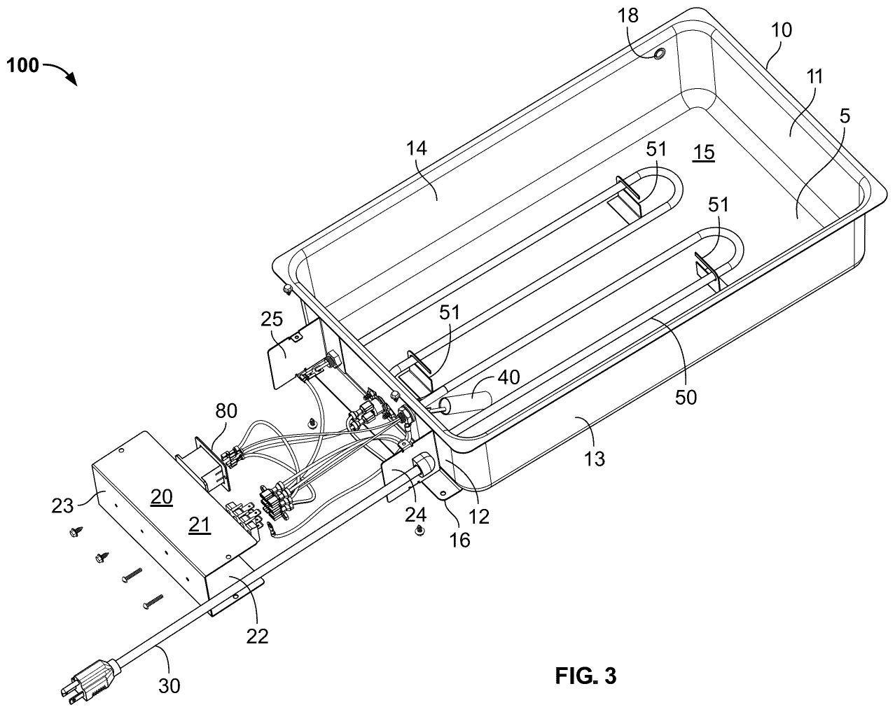

As best shown in FIGS. 3 and 10-11, control housing 20 in combination with end wall 12 are configured to house or enclose terminal ends 58,59 comprising respective electrical conductors 54,53 of electric heating element 50, terminal junctions 91,92, thermostat 70, terminal end 61 of reed switch 60, relay 80, terminal block 90, and electrical wires connecting all of the foregoing. Control housing 20 includes top wall 21, bottom wall 22, end wall 23, bracket 24, and bracket 25. Top wall 21, bottom wall 22, end wall 23, bracket 24, and bracket 25 may all comprise a sheet metal, such as a stainless steel. In other embodiments, top wall 21, bottom wall 22, end wall 23, bracket 24, and bracket 25 may comprise a plastic. Brackets 24,25 may be configured as L-shaped brackets and secured to end wall 12 of pan 10 as described above. Top wall 21, bottom wall 22, and end wall 23 may comprise a single sheet of sheet metal pressed or formed into a U-shape as shown in the figures. In other embodiments, one or more of top wall 21, bottom wall 22, and end wall 23 may be welded together or otherwise fastened together from two or more separate pieces. As shown in the figures, the U-shaped portion of control housing 20 may be fastened to brackets 24,25 by welds or fasteners.

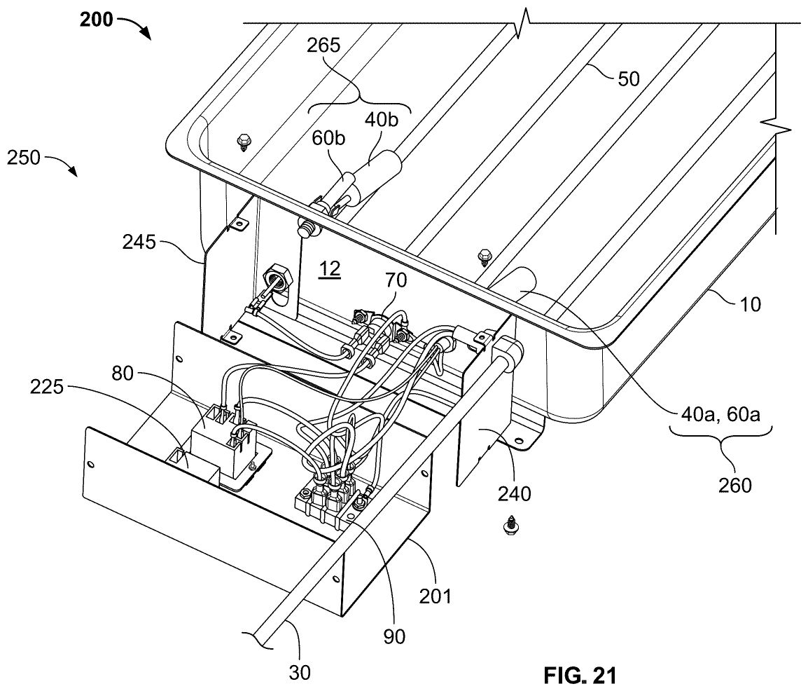

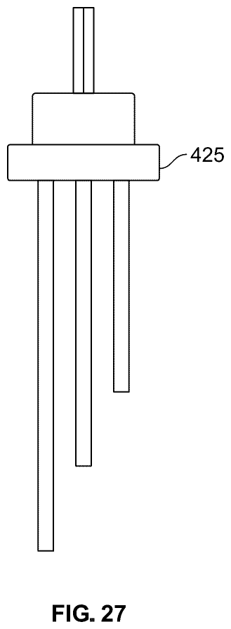

Turning now to FIGS. 21-29, there are shown various aspects of exemplary alarm or alert systems 250,350,450 for use with condensate pan systems of the instant disclosure. As illustrated in FIG. 21, representative condensate pan system 200 includes pan 10, control housing 201 comprising housing brackets 240,245, power cord 30, first water level sensing/detection device 260 comprising lower float 40a and lower reed switch 60a, second water level sensing/detection device 265 comprising upper float 40b and upper reed switch 60b, electric heating element 50, thermostat 70, smart relay 225, relay 80, and terminal block 90. In this embodiment, first water level sensing/detection device 260 and second water level sensing/detection device 265 are configured with the same components, features, and functionality, but first water level sensing/detection device 260 is positioned lower along end wall 12 than second water level sensing/detection device 265. More particularly, second water level sensing/detection device 265 may be positioned near a top edge of pan 10. In some embodiments, second water level sensing/detection device 265 may be positioned below overflow port 18. In other embodiments, second water level sensing/detection device 265 may be positioned at or above overflow port 18.

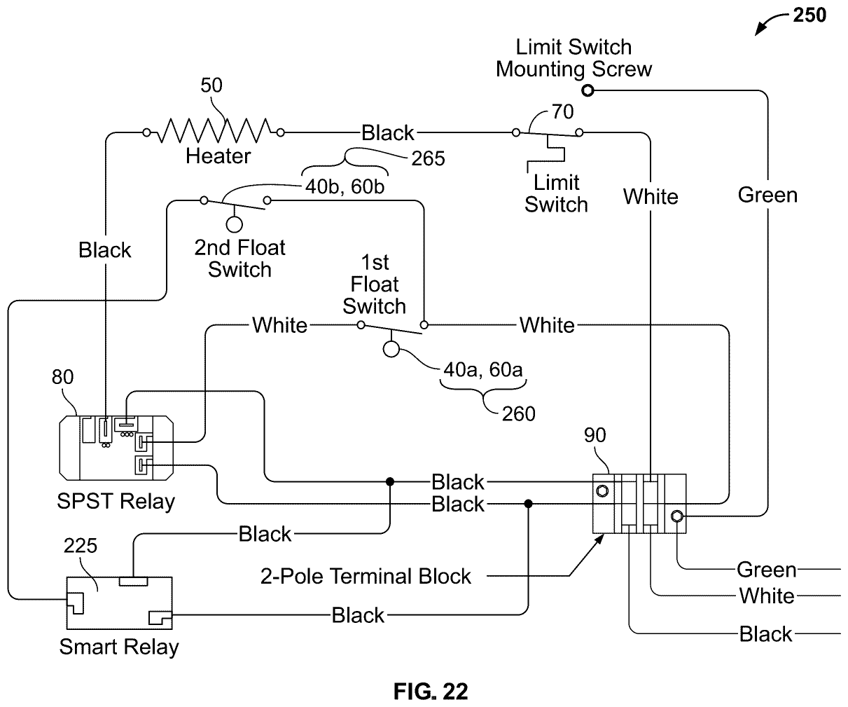

As illustrated in FIG. 22, optional alarm or alert system 250 may be added to condensate pan system 100 and can be configured to close the electrical contacts of second water level sensing/detection device 265 via upper reed switch 60b should upper float 40b sufficiently rise to a trigger height in pan 10 due to rising water level. Rising water level to the height in pan 10 where it triggers upper float 40b to close electrical internal contacts of upper reed switch 60b may be indicative of an error, fault, or malfunction of thermostat 70, electric heating element 50, relay 80, lower float 40a, and/or lower reed switch 60a and/or even prolonged loss of electrical power to the applicable condensate pan system.

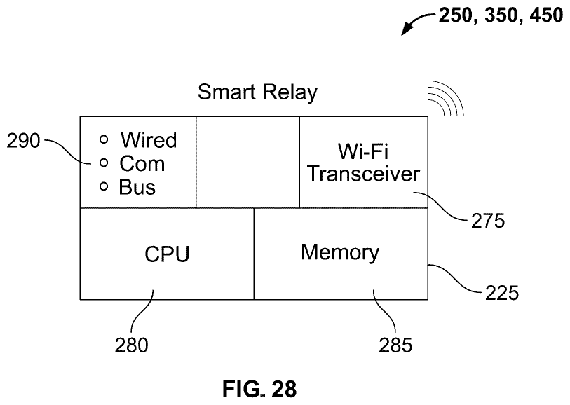

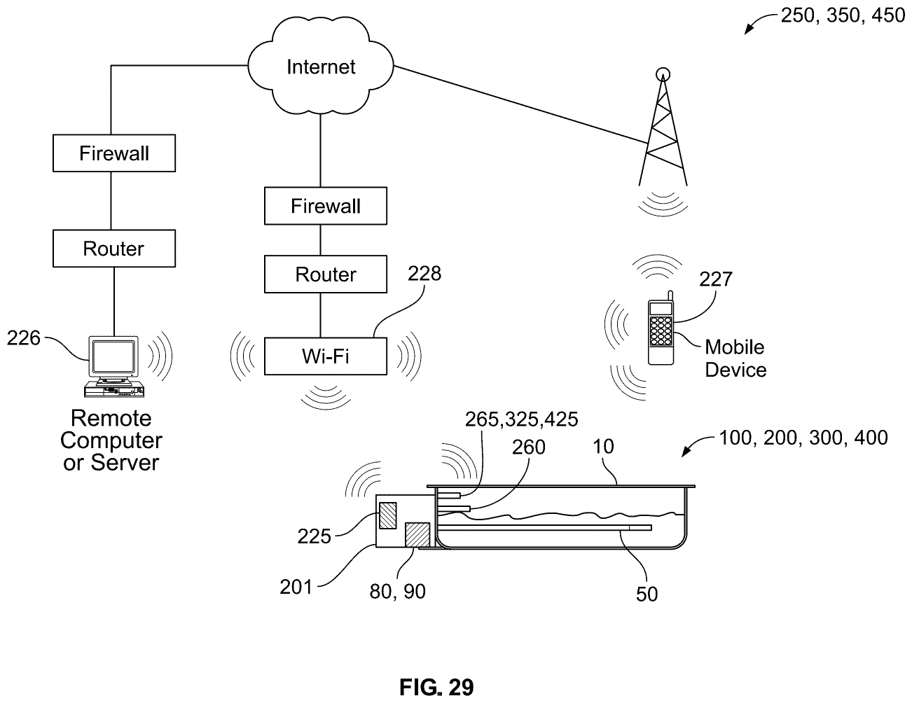

Once second water level sensing/detection device 265 closes the circuit, as shown in FIG. 22 electricity may be conveyed to smart relay 225 for wirelessly communicating an indication of an error, fault, or malfunction of one or more components of condensate pan system 200 to remote computer or server 226 and/or mobile device 227. In various embodiments, representatively illustrated in FIG. 28, smart relay 225 includes Wi-Fi transceiver 275, processor 280, memory 285, and wired communication bus 290 for wired or wireless communication of the indication of an error, fault, or malfunction. As shown in the exemplary embodiment of FIG. 29, the indication of an error, fault, or malfunction may be wirelessly communicated from smart relay 225 via, for example, Wi-Fi transceiver 275 to Wi-Fi access point 228, or to remote computer or server 226 comprising a Wi-Fi transceiver, or to mobile device 227 provided such devices are in suitable Wi-Fi proximity to smart relay 225 to receive wireless signals from smart relay 225. If at least one of Wi-Fi access point 228, remote computer or server 226, or mobile device 227 are in Wi-Fi proximity to smart relay 225, then any such device can communicate with any such other device via the Internet (and via cellular protocols to the Internet from mobile device 227). In this way, a remote user designated to receive such indication of an error, fault, or malfunction may be physically anywhere in the world and need not be proximate to the afflicted condensate pan system 250. As illustrated in FIGS. 21-29, to house more components including smart relay 225 and additional wiring, control housing 201 may be sized somewhat larger in height and/or volume than control housing 20. In the embodiments shown in FIGS. 21-29, control housing 201 may span approximately the height of end wall 12.

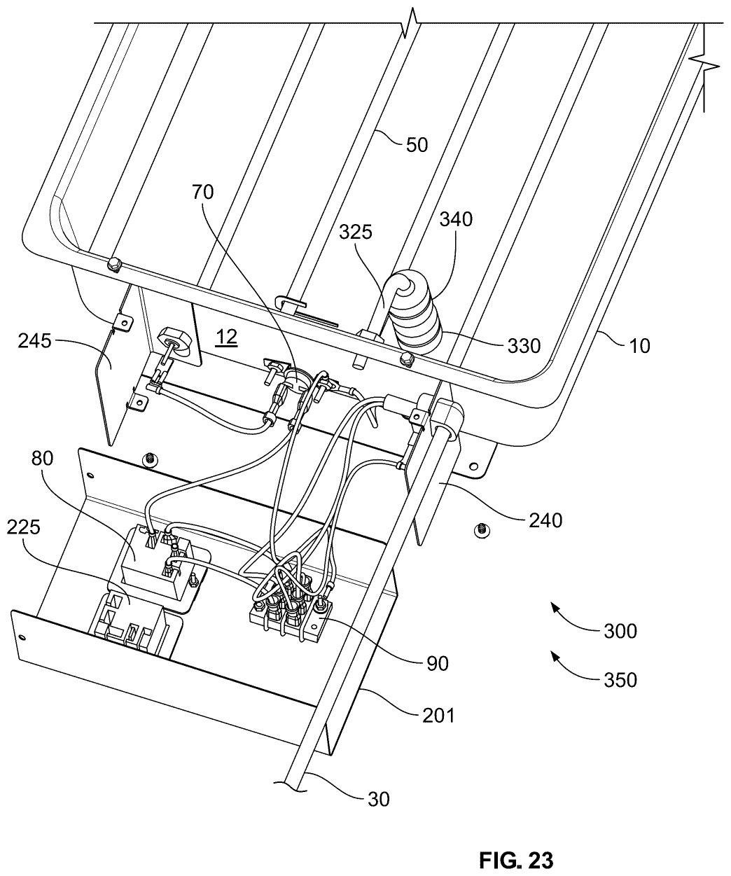

As illustrated in FIG. 23, representative condensate pan system 300 includes pan 10, control housing 201 comprising housing brackets 240,245, power cord 30, dual float water level sensing/detection device 325 comprising lower float 330 and upper float 340, electric heating element 50, thermostat 70, smart relay 225, relay 80, and terminal block 90. In this embodiment, dual float water level sensing/detection device 325 is configured to sense/detect two different water levels, and depending on which water level is detected, convey electricity to different components for different purposes. More particularly, dual float water level sensing/detection device 325 may be positioned near a top edge of pan 10 and configured to sense/detect a first, lower water level to energize/deenergize electric heating element 50, and a second, higher water level to communicate an indication of an error, fault, or malfunction of thermostat 70, electric heating element 50, relay 80, lower float 330, and/or even prolonged loss of electrical power to the applicable condensate pan system.

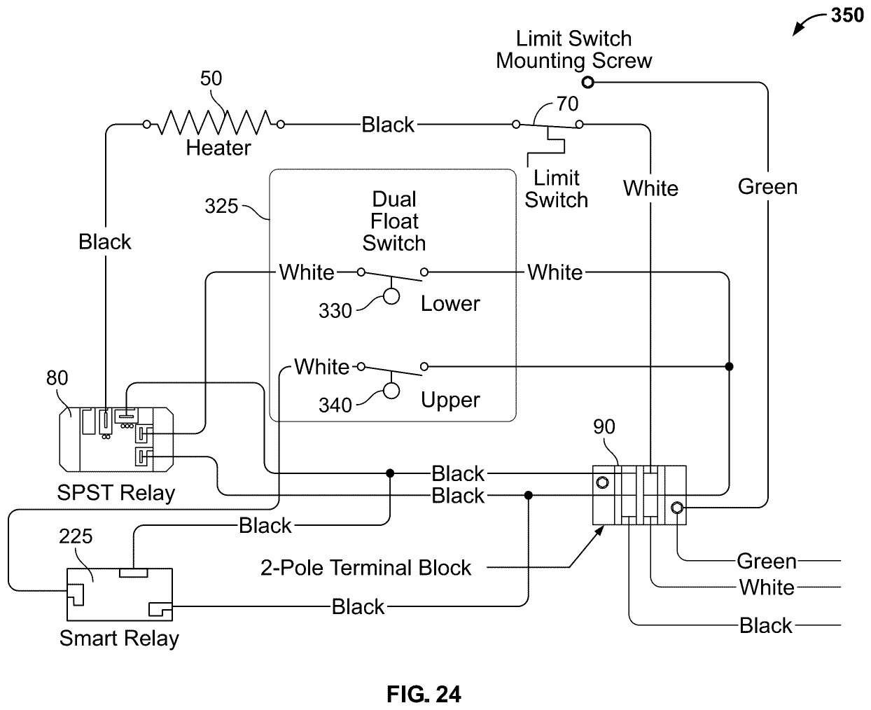

As illustrated in FIG. 24, optional alarm or alert system 350 may be added to condensate pan system 300 and can be configured to close the internal electrical contacts of dual float water level sensing/detection device 325 should water rise to a first trigger height associated with lower float 330 to cause electricity to flow to electric heating element 50. Should water recede below the first trigger height in a properly functioning apparatus when the electric heating element 50 is energized, the dual float water level sensing/detection device 325 may be configured to cease the flow of electricity to electric heating element 50 by opening the internal electrical contacts of associated with lower float 330 of dual float water level sensing/detection device 325. Should water rise for any reason to a second trigger height associated with upper float 340, such as due to a malfunctioning electric heating element 50, alarm or alert system 350 may be configured to initiate transmission of such indication of an error, fault, or malfunction to remote computer or server 226 and/or mobile device 227 as described above. Should water recede below the second trigger height, alarm or alert system 350 may be deactivated by opening the internal electrical contacts associated with upper float 340 to cease the flow of electricity to alarm or alert system 350.

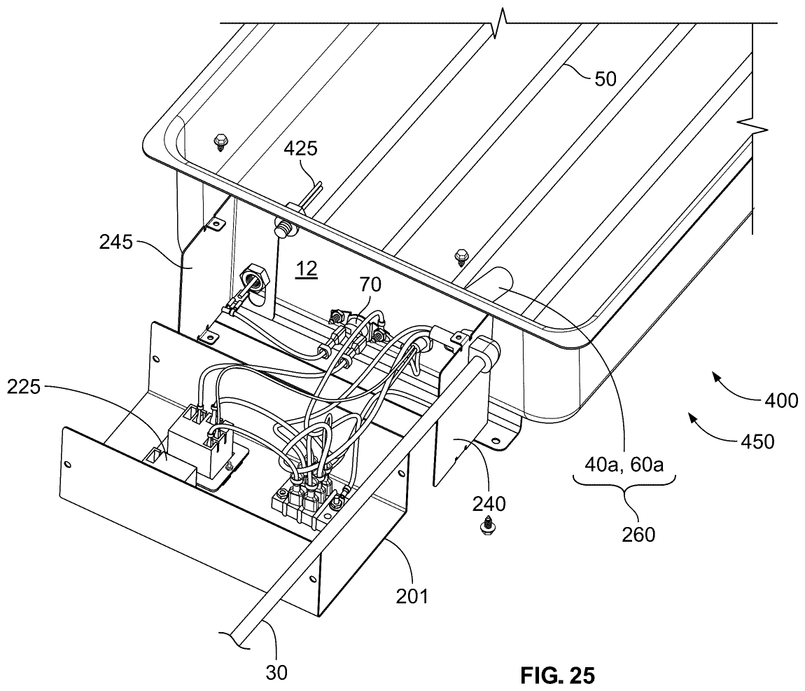

As illustrated in FIG. 25, representative condensate pan system 400 includes pan 10, control housing 201 comprising housing brackets 240,245, power cord 30, first water level sensing/detection device 260 comprising float 40a and reed switch 60a, second water level sensing/detection device 425 comprising a liquid conductivity sensor, electric heating element 50, thermostat 70, smart relay 225, relay 80, and terminal block 90. In this embodiment, first water level sensing/detection device 260 is positioned lower along end wall 12 than second water level sensing/detection device 425. More particularly, second water level sensing/detection device 425 may be positioned near a top edge of pan 10. In some embodiments, second water level sensing/detection device 425 may be positioned below overflow port 18. In other embodiments, second water level sensing/detection device 465 may be positioned at or above overflow port 18. In this embodiment, first water level sensing/detection device 260 is configured to operate as described above to energize/deenergize electric heating element 50, and second water level sensing/detection device 425 is configured to communicate an indication of an error, fault, or malfunction of thermostat 70, electric heating element 50, relay 80, first water level sensing/detection device 260, and/or even prolonged loss of electrical power to the applicable condensate pan system.

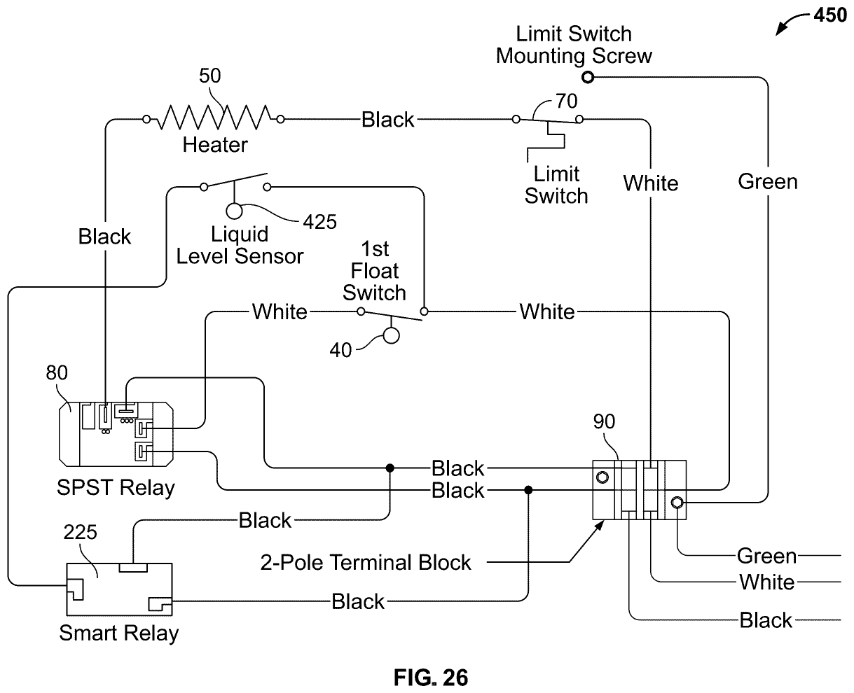

As illustrated in FIG. 26, optional alarm or alert system 450 may be added to condensate pan system 400. Should water rise to a second trigger height associated with second water level sensing/detection device 425, alarm or alert system 450 may be configured to initiate transmission of such indication of an error, fault, or malfunction to remote computer or server 226 and/or mobile device 227 as described above.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. A condensate pan system, comprising:
a pan for receiving a liquid, the pan comprising a bottom wall, a pair of opposed side walls connected to the bottom wall, and a pair of opposed end walls connected to the bottom wall and respective side walls;
an electric heating element for heating and evaporating the liquid, the electric heating element supported by the bottom wall;
a reed switch comprising sealed electrical contacts, the reed switch including a float configured to react to a varying level of the liquid in the pan, the reed switch configured to close the electrical contacts when the float detects that the level of the liquid is equal to or exceeds a minimum predetermined height, and configured to open the electrical contacts when the float detects that the level of the liquid is below the minimum predetermined height;
a thermostat positioned outside of the pan and proximate to the electric heating element, the thermostat configured to disconnect electrical continuity inside the thermostat upon detecting that a temperature of one of the opposed end walls of the pan is equal to or exceeds a predetermined temperature, and configured to maintain electrical continuity inside the thermostat upon detecting that the temperature is below the predetermined temperature; and
a relay comprising sealed relay contacts configured to close upon detecting electrical continuity with the thermostat and the reed switch to maintain electrical power to the electric heating element and configured to open upon detecting loss of electrical continuity with either the thermostat or the reed switch to disconnect electrical power to the electric heating element.

2. The condensate pan system of claim 1, wherein the pan is rectangular.

3. The condensate pan system of claim 1, wherein the electric heating element is a tubular sheathed heating element.

4. The condensate pan system of claim 1, wherein the electric heating element is supported above the bottom wall by at least one L-shaped support, wherein the support includes a base for connecting to the bottom wall and a slot for receiving the electric heating element.

5. The condensate pan system of claim 1, wherein the reed switch is horizontally oriented.

6. The condensate pan system of claim 1, wherein the float comprises a stainless steel or a polymer.

7. The condensate pan system of claim 1, including at least one heat conduction device comprising a first end and a second end, wherein the first end is connected to the electric heating element and wherein the second end is connected to a liquid-side surface of the one of the opposed end walls.

8. The condensate pan system of claim 7, wherein the thermostat comprises a face and the face is positioned against an outside surface of the one of the opposed end walls directly opposite the at least one heat conduction device.

9. The condensate pan system of claim 1, including a housing attached to the one of the opposed end walls, wherein the one of the opposed end walls is also a wall of the housing.

10. The condensate pan system of claim 9, wherein the housing is configured to enclose the thermostat and the relay.

11. The condensate pan system of claim 1, including a terminal block for connecting the relay to line electrical current.

12. A condensate evaporation system, comprising:
a vessel for receiving a liquid, the vessel comprising a wall;
an electric heating element positioned inside the vessel for heating and evaporating the liquid;
a reed switch comprising sealed electrical contacts, the reed switch including a float configured to react to a varying level of the liquid in the vessel, the reed switch configured to close the electrical contacts when the float detects that the level of the liquid is equal to or exceeds a minimum predetermined height, and configured to open the electrical contacts when the float detects that the level of the liquid is below the minimum predetermined height;
a thermostat positioned outside of the vessel and proximate to the electric heating element, the thermostat configured to disconnect electrical continuity inside the thermostat upon detecting that a temperature of the wall of the vessel is equal to or exceeds a predetermined temperature, and configured to maintain electrical continuity inside the thermostat upon detecting that the temperature is below the predetermined temperature; and
a relay comprising sealed relay contacts configured to close upon detecting electrical continuity with the thermostat and the reed switch to maintain electrical power to the electric heating element and configured to open upon detecting loss of electrical continuity with either the thermostat or the reed switch to disconnect electrical power to the electric heating element.

13. The condensate evaporation system of claim 12, wherein the electric heating element is a tubular sheathed heating element.

14. The condensate evaporation system of claim 12, wherein the electric heating element is configured for contact with the liquid.

15. The condensate evaporation system of claim 12, wherein the reed switch is horizontally oriented.

16. The condensate evaporation system of claim 12, wherein the float comprises a stainless steel or a polymer.

17. The condensate evaporation system of claim 12, including at least one heat conduction device comprising a first end and a second end, wherein the first end is connected to the electric heating element and wherein the second end is connected to the wall.

18. The condensate evaporation system of claim 17, wherein the thermostat comprises a face and the face is positioned against an outside surface of the wall directly opposite the at least one heat conduction device.

19. The condensate evaporation system of claim 12, including a housing configured to cooperate with the wall to enclose the thermostat and the relay.

20. A method of evaporating a liquid in a pan, comprising:
positioning an electric heating element in the pan;
positioning a reed switch comprising sealed electrical contacts, the reed switch including a float configured to react to a varying level of the liquid in the pan;
positioning a thermostat outside of the pan and proximate to the electric heating element, the thermostat configured to disconnect electrical continuity inside the thermostat upon detecting a temperature that is equal to or exceeds a predetermined value, and configured to maintain electrical continuity inside the thermostat upon detecting that the temperature is below the predetermined value;
positioning a relay comprising sealed relay contacts in electrical communication with the thermostat, the reed switch, and the electric heating element;
detecting the level of the liquid via the float;
detecting electrical continuity with the thermostat;
if the detected level of the liquid is equal to or exceeds a minimum predetermined height, and if electrical continuity with the thermostat exists, closing the relay contacts to electrically energize the electric heating element with electrical current to heat the liquid; and
if the detected level of the liquid is below the minimum predetermined height or if electrical continuity with the thermostat does not exist, opening the relay contacts to electrically disconnect the electric heating element from the electrical current.
